(19) United States
(12) Patent Application Publication
(10) Pub. No.: US 2006/0243011 A1
(43) Pub. Date: Nov. 2, 2006

(54) Solid carrier based microbial inoculants and method for manufacturing of such product

(76) Inventor: Edward Someus, Budapest (HU)

Correspondence Address: YOUNG & THOMPSON, 745 SOUTH 23RD STREET, 2ND FLOOR, ARLINGTON, VA, 22202, US

(21) Appl. No.: 10/560,596

(22) PCT Filed: Jun. 23, 2004
(86) PCT No.: PCT/HU04/00063

§ 371 Date: Jun. 30, 2006

(30) Foreign Application Priority Data
Jun. 23, 2003 (HU) P0301909

(51) Int. Cl. C05B 7/00

(52) U.S. Cl. 71/32

(57) ABSTRACT

Solid carrier-based microbial inoculants can be advantageously used for natural phosphorous supply of plant, biological control of soil born plant pathogens, biological degradation of organic contaminants, soil life and fertility improvement which solid carrier containing phosphorus, made of animal bone charcoal, and having grain size advantageously between 0.001 mm and 10 mm, pore size between 10 and 60,000 nanometer, macro porous structured, the specific area is between 1 and 500 m²/g, and the external and/or internal surface and/or internal pores are biologically active colonized with aerobic soil microorganisms under less than 30 degree Celsius temperature. Also described is a method for manufacturing and application of Nitrogen free solid carrier-based microbial inoculants which carrier is produced from animal bone by carbonisation process between 300 degree Celsius and 1000 degrees Celsius material core temperature in absence of ocygen, followed by cooling to below 50 degrees Celsius core temperature.

The scope of the invention is to provide a solid carrier colonized microbial inoculants for plant natural phosphorous supply, biological control of soil born pathogens, biological degradation of organic contaminants, soil life respectively fertility improvement; and method for production, effective storage for viability preservation and application of the microbial inoculunms.

The term of “microbiological consortiun” specifies one or several combinations of selected successful soil microorganisms, which by combined application enhance each other's effects.

The terms of “granulated microbiological substance” and/or “microbiological inoculums” specify such living microbiological substance containing material, including selected soil microorganisms and/or microbiological consortium that are immobilized on the external and/or the internal surface and/or pores of the carrier and able to solubilize the phosphorous content of the carrier to make it bio available for other living organisms.

The term of “microbial carrier” is specified as macro porous structured sterile or semi sterile stabile animal bone charcoal (“carbo animalis”) with high phosphorous and calcium content but low carbon content; preferably between 4-18 w/w %, which is produced from animal by-products and provides protection for the colonized microorganisms.

Bio fertilizers are liquid phase, suspended or carrier-based microbial inoculants containing sufficient cells of efficient strains of specific microorganisms, that help in enhancing the soil fertility, either by fixing atmospheric nitrogen, solubilisation/mineralization of phosphorous and potash or decomposing organic wastes by augmenting plant growth and promoting substances with their biological activities.

The introduced microbial inoculants without protective carrier have low survival rate and efficiency in natural soil environment because of the small amount of colony number per gram soil.

The CN1092397 patent is describing a multi-component organic composite fertilizer material and manufacturing method, containing the following ingredients: 3-10% microorganism, 40-60% organic carrier (brown coal and bone meal) and 20-40% inorganic fertilizer. The disadvantage of the method is that the bone meal without thermal inactivation containing human pathogen microorganisms.

According to the CN1310151 patent the black animal charcoal-rich in P, Ca, N and C- is produced by burning of animal bone at 1000-1500 degrees Celsius in oxygen deficit state for 2-3 hr. Black animal charcoal meal is produced by crushing black animal charcoal. Black animal charcoal meal is used in improving soil and compounding composite fertilizer.

The CN1310156 patent is describing a composite fertilizer, which is produced with animal bone black, urea, ammonium phosphate, potassium chloride, potassium sulphate, oilcake, fowl dung, calcium perphosphate, zeolite powder and adhesive, and through mixing, pelletizing and other steps.

The disadvantages of the above mentioned processes are that the animal bone charcoal is not used as a carrier for microbial inoculants, it is not colonized by microorganisms and the target application of the animal bone char coal is not linked with expedient solid state fermentation of the selected microorganisms.

It is known that in the biological and low input farming green manure-, papilionaceae, rotation of deeply rooted crops, organic compost, manure or different types of microbial or plant substances are used for the nutrient supplementation, in order to maintain or increase the soil fertility and/or biological activity. The general problem is the low bio available phosphorous content of these substances and the limited way of natural phosphorous fertilization in the agriculture system, where phosphorous is the second most important element of the plant nutrition.

Hereunder the known formulation methods of the microbial inoculants are shown:

It is known that most of the microbial substances—without any protective carrier—
need to be stored at low temperature, which is costly and during the cold storage the capacity of living is decreasing. It is also known that the survival rate of the microbial substances without any protective and/or carrier material is very low in the natural soil ecosystem. The low survival rate of the microbial substances results in inefficiency of the microbial substance for field and/or greenhouse application, thus the targeted application is inefficient.

The most frequently used possibilities of immobilization of the microorganisms include: (a) confinement of cells in interlaced gels or membrane like formations, (b) intercellular interlacing, (c) covalent bonding of cells to organic material, (d) adsorption of cells on the surface of a suitable carrier material. Application of both natural and synthetical carriers for immobilization of microbial inoculants is known.

The GB828882 patent is related to pelleted fertilizer produced by inorganic acid exploration of the original phosphate rock. Other fertilizer ingredients may be added to the fertilizer, such as ammonium sulphate or nitrate, potassium nitrate, chloride, sulphate or urea. The coating material of the fertilizer is pulverized phosphate rock, dolomite, charcoal and bone char.

According to PCT WO96/37433 (Nov. 28, 1996) patent after carbonisation of the animal bone the apatite content of the bone charcoal is treated by acidic process in the first phase, while in the second phase it is neutralized by alkalin solution for reduction of the apatite content of the animal bone. The disadvantage of this method is that the animal bone is treated by acidic and alkalin solutions which make it unsuitable for immobilization and storage of microbial inoculums from physical-chemical and biological point of view. Another disadvantage of the material is the high water solubility, resulting in non-effective application for low input and/or biological farming.

The US4506012 patent is related to the production of organic acids by a continuous fermentation process. Activated carbon as a support material for microorganisms is used in the continuous fermentation process.

The Enzyme Microb. Technol., 1987, vol. 9. 668-671 p. is related to the continuous solvent production using cells of Clostridium acetobutylicum immobilized by adsorption onto bone char.

In the above mentioned two processes the aim of the immobilization is the efficient use of microorganisms for production of active substance/product by continuous fermentation process. These processes and products are not adapted for biological crop protection and/or bio fertilizer applications.

The JP1307496 patent is related to a porous carrier for propagation of microorganisms. For production of the carrier 25-35 w/w % bone ashes and ceramics material powders are mixed and calcined. The bone ashes having the high porosity are formed by calcining bones. The patent is not related to the application of the carrier as a biological crop protection and bio fertilizer.

The JP62296877 patent is related to an immobilization carrier for microorganisms composed of carbon or graphite having modified surface.

JP62296878 patent is related to an inorganic carbon carrier (graphite, artificial graphite, carbon fiber, coke, carbon black and their precursors) for immobilization of microorganism.

The JP62044184 patent is related to carrier suitable for immobilization of microorganisms produced by impregnating of the plant (bamboo) wall tissue by organic solvent substance. The impregnated product is dried and then carbonised heated at 450 degrees Celsius in a non-oxidizing atmosphere.

The US4876288 patent is related to carrier material for immobilization of microorganisms. The carrier material comprises a dimensionally stable macro porous skeleton comprised of relatively coarse-grain granular material such as sinterable thermoplastic granules, and relatively fine grain micro porous material, such as activated charcoal, which are bonded together.

The disadvantages of the above-mentioned processes and materials, are that the applied carriers does not contain phosphorous and the micro porous structure is not available for the microorganisms.

It is well known that microbiological substances are applied for biological degradation of organic and/or halogenated organic contamination. The se methods are highly inefficient even in those cases where the bioremediation is applied with selected indigenous microorganisms. In most cases microorganisms, which are successfully applied in laboratory scale are less effective in field application conditions. The reason is that these laboratory fermented microbial inoculants are not able to successfully colonise in the soil rizosphere, subsequently low survival rate is achieved in the natural field environment, which is very different from the artificial laboratory conditions. Due to the lack of protective carrier, the survival rate of the microorganisms in the first introduction phase is very low.

According to the EP 0 104 571 (Sep. 19, 1983.) patent bio-catalytic enzyme is immobilized onto granulated activated carbon surface. The disadvantages of the method are that the activated carbon is chemically aggressive in the soil environment due to the high specific surface area, while the biological interaction between the carrier and microorganisms is not possible.

It is verifiable that the field of invention, both method and product, is absolutely different from other known methods and products and have considerable advantages versus known specific characters of the methods and products.

### SUMMARY OF THE INVENTION

The development aim of the method and product of the present invention is related to the selection of suitable carrier material for microbial colonization of the internal and/or external surface and/or internal space of the carrier, the efficient storage with preservation of the biotechnological viability of the microorganisms, providing complex physical and chemical co-effects, providing available phosphorous for plant by the microorganism, and the living capacity protection of the microorganisms during the introduction of the inoculants into the field environment.

The method of present invention is based on the recognition that if the selected microorganisms are colonized and sporulated on and in the internal and/or external surface and/or pores of the macro porous natural carrier material with high phosphorous content, then advantageous storage condition can be achieved with high survival rate for the microorganisms and/or microbial consortium during the storage and application. By the method of the present invention granulated natural microbial substance with flexible ecological adaptation properties can be efficiently produced which is capable for development of biological and physical/chemical interactions with the carrier during the different application phases.

The microorganisms are able to colonize on the external and internal surfaces and/or in the internal macro pores of the carrier, which can be advantageously enhanced by modification of the physical and chemical properties of the carrier material.

Accordingly, the animal bone charcoal solid carrier is advantageously characterised by having grain size between 0,001 mm and 10 mm, pore size between 10 and 60,000 nanometer, macro porous structured, specific surface internal area between 1 and 500 m²/g, high phosphorous content and does not contain any heavy metal or organic/inorganic contamination which can inhibit the microbial activity.

The aim of the application of the phosphorus content solid carrier of the present invention is the achievement of optimised immobilization, efficient storage of the microbial inoculants and widely biotechnological application of the product, where complex interactive mechanism between the solid carrier, microbial inoculants, plant and soil environment is developed. The main characteristics (pore size, distribution of the pore size, specific surface are, and chemical characters of the surface, grain-size distribution) of the carrier material are variable within wide bounds by the special selection of the raw material and manufacturing process.

The product of the present invention is microbial inoculants immobilized on a solid carrier material which can be advantageously applied for natural phosphorous supply of plant, biological control of soil born plant pathogens, biological degradation of organic contaminants, soil life and fertility improvement; characterised such as: the carrier material is phosphorus content animal bone charcoal, the grain size is advantageously between 0,001 mm and 10 mm, the pore size is between 10 and 60,000 nanometer, have macro porous structure, the specific area is between 1 and 500 m² μg, and the external and/or internal surface and/or internal pores are biologically active colonized with soil microorganisms.

The aim of the method of the present invention is production and application of microbial inoculants, in such a way, that the carrier is produced from animal bone by a carbonisation process over 300 degrees Celsius core temperature, followed by cooling to below 50 degrees Celsius core temperature, then the microbial inoculants—produced by conventional liquid phase fermentation—are introduced on and in the phosphorous content solid carrier external, internal surfaces and internal pores, advantageously by solid state fermentation process, so-called colonization process, then the water content of the microbial product manufactured by the following mentioned method is decreased to achieve long time storage for preserving the viability of the microorganisms; and before field introduction the microorganisms are activated by water and/or nutrient additives for development of the physical and chemical interaction.

One of the implementation methods is that the microbial inoculant is pre-fermented in liquid culture medium.

Another implementation of the method is that the microorganisms produced by solid state fermentation and colonized in the internal and external surface and pores of the carrier are induced for sporulation, in such a method that the water content is decreased below 45 w/w % at less then 50 degrees Celsius core temperature.

The third implementation of the method is that one or more microbial strains for the specific application are selected and make the microorganism strains—separately or together—to colonise the external and/or internal surface and/or internal pores of the carrier.

The fourth implementation of the method is that the carrier is pre-impregnated with nutrients for successful microbial colonization. The type and concentration of the nutrients are determined by the nutrient demand of each microbial strain and/or microbial consortium for colonization of the carrier, the adsorption rate of each nutrient and sporulation characteristics of the microorganism.

### EXAMPLES

The product and method of the invention is presented by the following examples:

Example 1 describes the manufacturing of the carrier

Example 2 describes the microbial colonization method of the carrier

Example 3 demonstrates the storage stability of the microbial inoculants

Example 4 demonstrates the biological control effects of the microbial inoculants on Capsicum annuum plant against soil born pathogens.

Example 5 demonstrates another application of the granulated product of invention.

### Example 1

In this example we have dried 10 kg 0.001 mm-10 mm grain sized animal bone meal to 12 w/w % moisture content, carbonised the material in absence of air at 30 Pascal below atmospheric pressure and continuously heated up the material from 20 degrees Celsius input temperature to 850 degrees Celsius core temperature in one hour. During the carbonisation procedure 64 w/w % volatile compounds are removed from the material and the remaining 34 w/w % bone charcoal has been cooled to 20 degrees Celsius and stored under semi-sterile conditions. During the thermal treatment of the carrier according to the invention, the specific surface area and the macro porous internal structures of the bone charcoal hydroxyapatite develops and will, combined with carbon, be available for adsorption and/or absorption processes.

### Example 2

This example describes the microbial colonization method of the carrier. The first step is the selection of the suitable soil microorganisms with known methods. The following criteria need to be applied for the selection: the microorganism strain is non-human/animal/plant pathogen, having ability for colonization of the carrier and/or having antagonistic effect against economically important soil born plant pathogens and/or is suitable for immobilization of the phosphorous content of the carrier and/or having effect of biodegradation of soil and/or water organic contaminants and/or having effect of biological regeneration of contaminated adsorption/absorption material and/or having effect of adsorption/absorption of the contaminants.

Animal bone charcoal surface colonization trial is completed with mycelia of Streptomyces griseoviridis strain. The maintenance of the strain has been made on Soya flour agar nutriment with the following composition and concentration per litre: Soya flour (20 g), CaCO₃ (2 g), NaCl (3 g), maize jam (6 g), glucose (10 g), agar (20 g), solution of trace elements (10 ml), on which nutriment of the microbiological colonization is made on 28-30 degrees Celsius. Ten grams of animal bone charcoal, manufactured as per the first example, has been placed into a petri dish. 2000 μl of microbiological spore suspension has been pre-cultivated in 500 ml liquid Soya flour agar nutriment. During the 18 hours pre-cultivation process on 28 degrees Celsius the cultivates has been agitated with 230 rotations per minute. This germinated spore cell suspension has been applied for inoculation of the animal bone charcoal. The animal bone charcoal has been impregnated with nutriments; the pre-cultivated cells have been inoculated to the surface of the carrier and have been incubated under aerobic conditions on 28 degrees Celsius during 72 hours.

The result has been that the external and internal surface of the solid carrier animal bone charcoal has been, completely colonized with mycelia, the colony differentiated and spores have been developed at the end of the growth cycle.

The solid-state fermentation has been completed by dewatering, stabilization and formulation with non-oxidizing agents. The formulation is made by paraffin oils, vegetable oils, different types of sugar and/or bentonite. After formulation the active microbiological substance concentration has been advantageously 3.4×10¹⁰ CFU/g.

For after control of the test the animal bone charcoal carrier-based microbial inoculants have been inoculated into non-sterile Soya flour agar culture medium. The carrier-based microbial inoculants have been developing on the culture medium and after 36 hours spores have developed. The result demonstrated that the carrier-based microbial inoculants on the external and internal surface of the carrier have not lost the vital capacity. The active microbiological substance concentration has been advantageously 3.4×10¹⁰ CFU/g.

### Example 3

This example—without limiting the fields of the applications of the invention—demonstrates the storage stability of the microbial inoculants, where living cell determination has been made in different periods.

| | CFU/g animal bone | CFU/g animal bone |
|---|---|---|
| | charcoal carrier-based | charcoal carrier-based |
| Storage | microbial inoculants on | microbial inoculants on |
| time, day | 4° C. temperature | 25° C. temperature |
| 0 | 3.4 × 10¹⁰ | 3.4 × 10¹⁰ |
| 20 | 3.4 × 10¹⁰ | 3.4 × 10¹⁰ |
| 150 | 3.2 × 10¹⁰ | 3.1 × 10¹⁰ |
| 360 | 3.0 × 10¹⁰ | 2.9 × 10¹⁰ |

### Example 4

Demonstrates the biological control effects of the carrier-based microbial inoculants by separate tests on Capsicum annuum plant against soil born pathogens, such as Fusarium spp., Rhizoctonia spp. and Botrytis cinerea. Screened and selected strains of Trichoderma harzianum and Streptomyces griseoviridis have been separately cultivated on the carrier's surfaces, and then mixed into plant beds. In separate test programme for each pathogen, 25 pathogen-infected plants have been treated with carrier-based microbial inoculants and 25 pathogen-infected control plants observed, in four series each. During the tests the yield increasing effect of the carrier-based microbial inoculants has been observed as well. As a result, in the case of untreated control plants, the infected plant ratio has been 93%, while in the carrier-based microbial inoculants treatment cases the infected plant ratio has decreased to 7%. In comparison with the healthy plant yields, the treated plants increased their yields with 28%. Based on the results, this is to be stated that the carrier-based microbial inoculants product have been successful against the tested soil borne plant pathogens and significant yield increase have been observed as well.

### Example 5

This example demonstrates the effective treatment of high-chlorinated dense and obsolete contaminated soil. Soil subsurface contamination has been identified between minus 3 to 5 m level, consisting of up 3600 mg/kg pollution concentration clusters. By sampling, the adapted microbiological strains have been screened and selected, such that by solid-state fermentation methods these strains have been colonized on the surfaces of the 1-2 mm sized animal bone charcoal carrier. The carrier-based microbial inoculants with 3.4×10¹⁰ CFU/g cell concentration have been injected into the soil subsurface contamination clusters in 0.75 w/w % volume to contaminated soil. The soil subsurface injection is executed with two methods, such as point injection over the ground water level at minus 3-4 m level, and as permeable active barrier continuous construction below the ground water level at minus 4-5 m level. By control on day 120 it has been observed that the concentration has decreased from 3600 mg/kg to 375 mg/kg, the contamination degraded into low chlorinated compounds less risk stabile products, and the permeable active barrier bound 92% of the ground water contamination streams, thus preventing the spread of organic and/or inorganic contamination, including heavy metals, through ground water flow.

The method of the present invention—for production, application and long life storage of solid carrier-based microbial inoculants in high phosphorous content granulated sterile carrier, has the following advantages:
The carrier-based microbial inoculants improve the microbial survival rate by immobilization of microorganisms into the stabile solid carrier (advantageously animal bone charcoal) with high phosphorous content and specific physico-chemical character. The survival rate—at the first period of the field application—will significantly be increased compared to the application without efficient protective carrier, where more than 90% of the introduced microorganisms are declared during the first phase of the inoculation.
Improving of the storage performance of the biological substance from days/weeks without use of cooling to at least several months, thereby avoiding loss of biological activity and viability of the microbial substance. The immobilization into the high phosphorus content animal bone charcoal allows microorganisms to be stored in a dry, uniform state and remain viable for as long as 1 year.
The biofilm, which is formed by the microorganisms outside and inside the surface of the carrier, increases the microbiological activity and the adaptation of the microorganisms to the environment surrounding them.

During the biofilm formation the microbial community adheres to the carrier surfaces, developing an interactive mechanism with the carrier material, solubilizing the phosphorous and is embedded in a matrix of bacterial origin. Bio flm formation is a successive process beginning with the adsorption of organic substances on a solid surface followed by sequential colonization by various species. The most important feature of a bio film is the protection it provides for the attached microbial community or communities. The thick matrix that helps adhesion also makes the biofilm resistant to harm from many hazards such as bacteriophages, biocides and antibiotics.
The carrier with phosphorous content can simultaneously provide a growing surface for the activity of the aerobic and anaerobic microorganisms, because the external surface of the carrier is rich in oxygen, which means that the environment is aerobe, whilst the inner domain of the carrier material is of lower-oxygen anaerobic region. Due to the complex macro porous structure of the animal bone charcoal carrier, complex biocoenosis developed, significantly improving the field application efficiency. The development of these combined aerobic-anaerobic regions is arising from the advantageously porous structures of the carrier.
Natural soil fertility enhancing by sequenced P/Ca supply. The phosphorous content of the animal bone char carrier is mobilized by the activity of the microorganisms, making it bio available for plants. The natural substance avoids the periodic P deficit of the plant and substitute artificial fertilizers, with negative effects on the soil diversity and pH. The P bio availability released from animal bone char carrier to plant is time sequenced, it is not leached out to ground water, but it is rather developing an interactive coherence between microorganisms and/or microbial consortium, animal bone char carrier, plant rizosphere uptake and the biological, organic and inorganic components of the soil. The natural phosphorous supply and the developed biological interaction are increasing the natural defence mechanisms of the plant and restoring the natural balance of the soil.
The carrier with macro porous structure advantageously modifies the physical-chemical properties of the soil and enhancing the microbial inoculation of the soil. The advantages of the addition a carrier with expanded surface area and macro porous internal structure into the soil are the positive dislodging effect on the soil structure which results in the better oxygen supply for the soil microorganisms. The better oxygen supply in the soil is enhancing the biological activation of the soil and the degradation of the organic hydrocarbons.
The typical raw material of the carrier is the animal bone, which is carbonised at high temperature during the manufacturing of the carrier. The animal bone char carrier contains only 4-18 w/w % carbon, while the main component is the calcium phosphate. The calcium and phosphorous content of the carrier is slowly mobilized—make it bio available for plant in the soil rizosphere—by the activity of the immobilized and soil microorganisms. Direct physical-chemical and biological interaction and nutrient bridge build up between the immobilized microorganisms, soil microorganisms and carrier. The positive impact of the application of the carrier is not only the calcium and phosphorous supply, but it is also able to stabilize and neutralize the soil acidity.
The granulated carrier is natural, non-toxic substance; its nutrient content is slowly mobilized by the activity of the immobilized and natural soil microorganisms and makes it a natural soil component, whereas by application the risk of secondary contamination is removed. The application of the carrier has no negative impact on the environment and ecosystem. The immobilized microorganisms and/or microbial consortium have a selective effect on the plant pathogen soil borne organisms without any negative impact on the activity of the natural antagonistic organisms, plant and animal. The natural defence mechanisms of the plant, the natural balance and self-regulating activity of the soil ecosystem are recovering by the application of the natural carrier.

The application areas of the present invention—without any restriction of the patent protection—are the following:
The method and the granulated product is effective for combined applications such as biological, physical-chemical interaction in soil, natural calcium and/or phosphorous supply and/or biological control of plant pathogens and/or neutralization of soil acidity in conventional and/or low input and/or organic agricultural production systems.
The animal bone char with high calcium and phosphorous content is a macro porous solid structured carrier for biological substances and nutrient source for plants. It is capable of immobilization of microbial substance and/or combined microorganisms and/or with flexible ecological adaptation features, both in acidic and/or basic soil conditions, against soil borne plant pathogens with wide host plant species.
The method and granulated carrier product is also suitable for biological disinfection, natural reduction of the population of the soil borne plant pathogens, which can infect the different plant compartments in the soil. The mechanism is based on the antagonistic effect of the natural soil microorganisms, which can be antibiotics production and/or competition for nutrients, oxygen or field and/or predation (hyperparazitism, fungivorous, nematode cumsumer fungies).
The method and granulated carrier product is also suitable for high efficient and accelerated biological remediation of organic and/or halogenated organic contaminated soil and/or groundwater. Selected natural soil microorganisms with soil contamination degrading ability can also be immobilized into the carrier. By application of protective carrier we can provide short adaptation time for the introduced microorganisms and/or microbial consortium to the contaminated environment.
The method and granulated carrier product is also suitable for biological activated filter for small-, medium- and large capacity biological water treatment and/or for industrial water purification. The internal and external surface of macro porous carrier is able to adsorb with high efficiency the organic water pollutants. The adsorbed organic pollutants act as a continuously available nutrient source for the microorganisms attached to the carrier. The internal part of the carrier is anaerobe while the external is reach in oxygen, which is preferred by the aerobic microorganisms.
The method and granulated carrier product is also suitable for biological regeneration of organic and/or halogenated organic contaminated activated carbon. For biological regeneration the activated carbon is mixed with the microbial substances, which is immobilized into the carrier. By application of protective carrier we can provide short adaptation time for the introduced microorganisms and/or microbial consortium to the contaminated environment.
Furthermore, the present invention can advantageously be applied in every type of applications where microbiological substances are needed together with phosphorous and the microbial substances need to be protected during the long storage life and in the first phase of the introduction.

1-6. (canceled)

7. The solid carrier-based microbial inoculants advantageously used for natural phosphorous supply of plant, biological control of soil born plant pathogens, biological degradation of organic contaminants, soil life and fertility improvement is characterised by that the solid carrier containing phosphorus, made of animal bone charcoal, and having grain size advantageously between 0.001 mm and 10 mm, pore size between 10 and 60,000 nanometer, macro porous structured, the specific area is between 1 and 500 m²/g, and the external and/or internal surface and/or internal pores are biologically active colonized with aerobic soil microorganisms under less than 30 degree Celsius temperature.

8. Method for manufacturing and application of solid carrier-based microbial inoculants is characterised by that the Nitrogen free carrier is produced from animal bone by carbonisation process between 300 degree Celsius and 1000 degree Celsius material core temperature in absence of oxygen, followed by cooling to below 50 degrees Celsius core temperature, then the microbial inoculants—produced by conventional liquid phase fermentation—are introduced on and in the phosphorous content solid carrier external and/or internal surfaces and/or internal pores, advantageously by solid state fermentation process resulting in aerobic microbiological colonization, then the water content of the microbial product is decreased to achieve long time storage for preserving the viability of the microorganisms; and before field introduction the microorganisms are activated by water and/or nutrient additives.

9. According to claim 8. the method is characterised by that the microbial inoculants is pre-fermented in liquid culture medium.

10. According to claim 8 the method is characterised by that the water content is decreased below 45 w/w % at less then 50 degrees Celsius core temperature for the sporulated microorganisms produced by solid state fermentation and colonized in the internal and/or external surface of the carrier.

11. According to claim 8 the method is characterised by that one or more microbial strains are selected and make the microorganism strains separately or together.

12. According to claim 8 the method is characterised by that for successful microbial colonization the carrier is pre-impregnated with nutrient.

13. According to claim 9 the method is characterised by that the water content is decreased below 45 w/w % at less then 50 degrees Celsius core temperature for the sporulated microorganisms produced by solid state fermentation and colonized in the internal and/or external surface of the carrier.

14. According to claim 9 the method is characterised by that one or more microbial strains are selected and make the microorganism strains separately or together.

15. According to claim 9 the method is characterised by that for successful microbial colonization the carrier is pre-impregnated with nutrient.

16. According to claim 10 the method is characterised by that for successful microbial colonization the carrier is pre-impregnated with nutrient.

17. According to claim 11 the method is characterised by that for successful microbial colonization the carrier is pre-impregnated with nutrient.
